(19) United States
(12) Patent Application Publication
(10) Pub. No.: US 2020/0027671 A1
(43) Pub. Date: Jan. 23, 2020

(54) BUTTON, SWITCH ASSEMBLY AND COMPUTER HOST

(71) Applicant: Wistron Corp., New Taipei (TW)

(72) Inventor: Zhao-Ping FU, New Taipei (TW)

(21) Appl. No.: 16/212,743

(22) Filed: Dec. 7, 2018

(30) Foreign Application Priority Data
Jul. 17, 2018 (CN) 201821136293.6

(51) Int. Cl. H01H 13/10; H01H 13/14

(52) U.S. Cl. CPC H01H 13/10; H01H 13/52; H01H 13/14

(57) ABSTRACT

The disclosure provides a button. The button includes at least one guiding component and a main body. The main body has at least one guiding surface. The guiding surface of the main body is slidably connected to the guiding component so as to allow the guiding component to guide the main body to move. In addition, the disclosure also provides a switch assembly and a computer host that have the button.

### CROSS-REFERENCE TO RELATED APPLICATIONS

This non-provisional application claims priority under 35 U.S.C. § 119(a) on Patent Application No(s). 201821136293.6 filed in China on Jul. 17, 2018, the entire contents of which are hereby incorporated by reference.

### TECHNICAL FIELD

The disclosure relates to a button, a switch assembly and the computer host, more particular a button, a switch assembly and a computer host that have a guiding component for guiding direction.

### BACKGROUND

A button is a switch mechanism for controlling some aspects of an electronic product, such as a power button of a notebook computer or desktop computer or a SID switch button. In order to provide a good tactile feedback and make the button responsive, the configuration of the button is a critical factor.

Taking a notebook computer for instance, except for a circle-shaped button, there are rectangular-shaped buttons on the notebook computer. But the rectangular-shaped button is easily pivoted to fail to activate the switch when an external force applied to the button is not uniform. In detail, due to the shape of the rectangular button, the rectangular button is easily pivoted and off track from the path for activating the switch when a force is applied to the end portion of the button, consequently, the button may have a high chance of being moved in a wrong direction and being stuck in the casing.

### SUMMARY OF THE INVENTION

One embodiment of the disclosure provides a button The button includes at least one guiding component and a main body. The main body has at least one guiding surface. The guiding surface of the main body is slidably connected to the guiding component so as to allow the guiding component to guide the main body to move.

Still another embodiment of the disclosure provides a switch assembly which is configured to be mounted to a casing. The switch assembly includes a switch and a button. The switch is configured to be mounted in the casing. The button, configured to press the switch, includes at least one guiding component and a main body. The guiding component is configured to be fixed in the casing. The main body is configured to be slidably disposed on the casing. The main body has at least one guiding surface. The guiding surface is slidably connected to the guiding component so as to allow the guiding component to guiding the main body to move toward or away from the switch.

Yet another embodiment of the disclosure provides a computer host. The computer host includes a casing, a switch and a button. The switch is mounted in the casing. The button is configured to press the switch. The button includes at least one guiding component and a main body. The guiding component is fixed in the casing. The main body slidably disposed on the casing. The main body has at least one guiding surface. The guiding surface of the main body is slidably connected to the guiding component so as to allow the guiding component to guide the main body to move toward or away from the switch.

### BRIEF DESCRIPTION OF THE DRAWINGS

The present disclosure will become better understood from the detailed description given herein below and the accompanying drawings which are given by way of illustration only and thus are not intending to limit the present disclosure and wherein:

FIG. 1 is a perspective view of a button, a casing and a switch according to a first embodiment of the disclosure;

FIG. 2 is another perspective view of the button, the casing and the switch in FIG. 1;

FIG. 3 is an exploded view of the button, the casing and the switch in FIG. 2;

FIG. 4 is a partial enlarged cross-sectional view of the button, the casing and the switch in FIG. 2;

FIG. 5 is the partial enlarged cross-sectional view of the button, the casing and the switch in FIG. 4 while a main body of the button is pressed;

FIG. 6 is a cross-sectional view of a button, a casing and a switch according to a second embodiment of the disclosure;

FIG. 7 is a cross-sectional view of a button, a casing and a switch according to a third embodiment of the disclosure; and

FIG. 8 is a cross-sectional view of a button, a casing and a switch according to a fourth embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

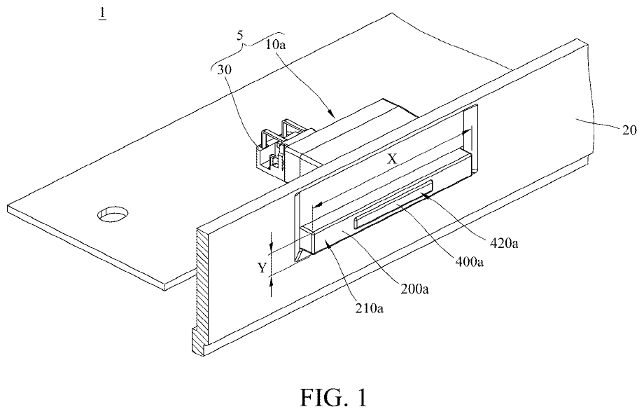

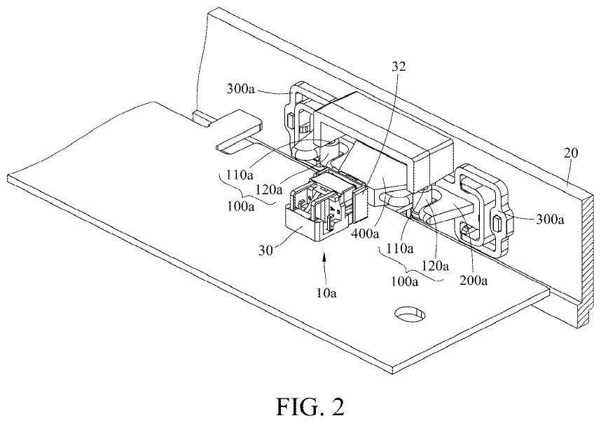

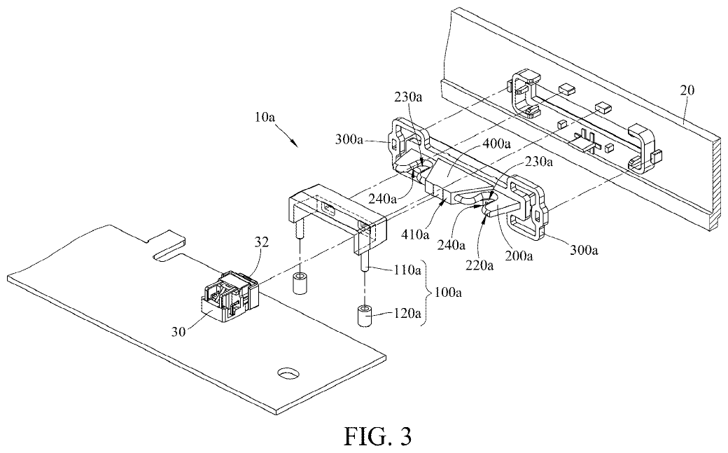

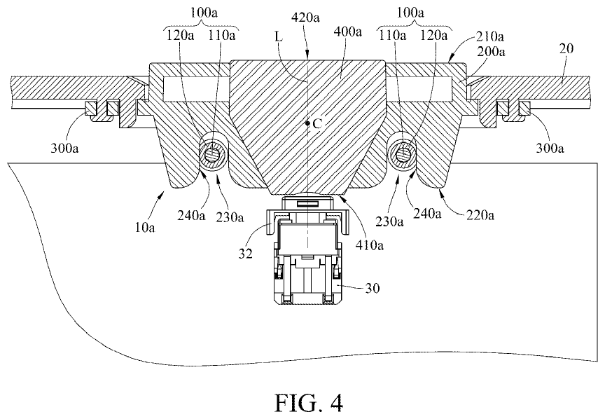

Please refer to FIG. 1 to FIG. 4. FIG. 1 is a perspective view of a button, a casing and a switch according to a first embodiment of the disclosure. FIG. 2 is another perspective view of the button, the casing and the switch in FIG. 1. FIG. 3 is an exploded view of the button, the casing and the switch in FIG. 2. FIG. 4 is a partial enlarged cross-sectional view of the button, the casing and the switch in FIG. 2.

As shown in FIG. 1 and FIG. 2, this embodiment provides a computer casing 1. The computer casing 1 includes a switch assembly 5 and a casing 20. The switch assembly 5 is mounted on the casing 20, and the switch assembly 5 includes a button 10a and a switch 30. The button 10a is configured to press the switch 30 which is located in the casing 20. The casing 20 is, for example, a casing of a server or a desktop computer. The switch 30 is, for example, a SID switch or a power switch. The switch 30 has a press part 32. Pressing the press part 32 is able to switch the switch 30 from an activated state to an inactivated state or from the inactivated state to the activated state.

As shown in FIG. 3 and FIG. 4, the button 10a includes two guiding components 100a, a main body 200a and two elastic arms 300a. Each of the guiding components 100a includes a mount post 110a and a rotatable component 120a. The two mount posts 110a are fixed to the casing 20a by, for example, partially melting them. In this embodiment, the rotatable components 120a are hollow cylinders, and the two rotatable components 120a are respectively and rotatably sleeved on the two mount posts 110a. In this or another embodiment, there may be a flange on an end of each mount post 110a that can prevent the rotatable component 120a from falling off from the mount post 110a, and the flange may be made from partially melting the end of the mount post 110a. In other embodiments, there may be a ring-shaped stopper sleeved on the end of the mount post for preventing the rotatable component from falling off.

In the disclosure, the rotatable component 120a may not be a hollow cylindrical component. In some other embodiments, the rotatable component may be in a bead-shaped component.

From the view of FIG. 1, the front side of the main body 200a of the button 10a is in, for example, a long and narrow shape. As shown in FIG. 1, the ratio of the length X of the main body 200a to the width Y of the main body 200a is larger than 3. The main body 200a is slidably disposed on the casing 20 so that the main body 200a is movable toward or away from the switch 30. In detail, as shown in FIGS. 1 and 3, the main body 200a has a first side surface 210a, a second side surface 220a and two grooves 230a. The second side surface 220a is opposite to the first side surface 210a. In other words, the first side surface 210a is at the front side of the main body 200a, and the second side surface 220a is at the rear side of the main body 200a. The first side surface 210a is configured to be pressed by an external force, and the second side surface 220a can be moved toward or away from the switch 30 while the external force is applied on the first side surface 210a.

Defining a central line L passing through both the switch 30 and a central point C of the main body 200a, the two grooves 230a extend from the second side surface 220a toward the first side surface 210a, and the two grooves 230a are respectively located on two opposite sides of the central line L. Each of the two grooves 230a has a guiding surface 240a which is located on a side of the groove 230a facing the central line L. That is, the two guiding surfaces 240a extend from the second side surface 220a toward the first side surface 210a. The two rotatable components 120a of the two guiding components 100a are respectively in contact with the two guiding surfaces 240a. Therefore, when the main body 200a is moved toward or away from the switch 30, the two rotatable components 120a of the two guiding components 100a can guide the movement of the main body 200a in a rotating manner.

In addition, in this embodiment, the guiding surface 240a is a curved surface, which helps to reduce the contact area between the guiding surface 240a and the rotatable component 120a so as to enable the main body 200a to smoothly move with respect to the casing 20. However, the guiding surface 240a may not be a curved surface. For example, in some other embodiments, the guiding surface may be a flat surface; in such a case, the rotatable component may be a bead-shaped component, such that the contact area between the guiding surface and the rotatable component is still small.

Furthermore, the shape of the front side of the main body 200a is not restricted. For example, in some other embodiments, the shape of the front side of the main body may be in a circle or triangle.

Two ends of the two elastic arms 300a are respectively connected to two opposite sides of the main body 200a, and the other ends of the two elastic arms 300a are configured to be fixed to the casing 20. The two elastic arms 300a are configured to provide elastic potential energy for spring the main body 200a back to its original position. It is noted that the quantity of the elastic arms 300a is not restricted. For example, in some other embodiments, the button may only include one elastic arm 300a. Furthermore, the shape of the elastic arm 300a is either not restricted. For example, in some other embodiments, the button may only include one elastic arm and the elastic arm may be in a ring shape surrounding the main body.

In addition, in this embodiment, the main body 200a can be moved back to its original position by the elastic force provided by the elastic arms 300a, but the present disclosure is not limited thereto. In some other embodiments, the elastic arm may be replaced with a spring, and two opposite ends of the spring are respectively connected to the casing and main body, such that the spring is able to spring the main body back to its original position.

The button 10a of this embodiment further includes a light guiding component 400a. The light guiding component 400a is embedded into the main body 200a, and the light guiding component 400a has an incident surface 410a and an illuminating surface 420a. The incident surface 410a faces the switch 30, and the illuminating surface 420a is exposed from the front side of the casing 20. The incident surface 410a is configured to receive and guide light emitted by a light source (not shown in figures) on the switch 30 to the illuminating surface 420a.

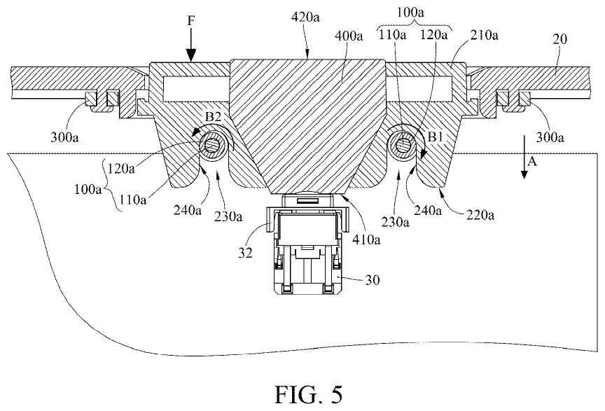

Please refer to FIG. 4 and FIG. 5. FIG. 5 is the partial enlarged cross-sectional view of the button, the casing and the switch in FIG. 4 while a main body of the button is pressed.

When an external force is applied on an area that away from the central area of the first side surface 210a of the main body 200a, the main body 200a may experience a large pivot torque, but with the help of the rotatable components 120a sliding along the guiding surfaces 240a, the main body 200a is able to be moved along the desired direction, thereby preventing the main body 200a from pivoting to get stuck in the casing 20 and preventing the light guiding component 400a from being off track from the path for activating the switch 30. That is, the guiding components 100a ensure the main body 200a to move along a straight direction toward the switch 30 (e.g., a direction A as shown in the figure) even when the force is not applied on the central area of the front side of the main body 200a. Also, during the movement of the main body 200a along the direction A, the guiding surfaces 240a force the rotatable components 120a to respectively rotate in a direction B1 and B2, therefore the friction between the main body 200a and the guiding components 100a can be reduced, thereby enabling the main body 200a to move smoothly with respect to the casing 20.

It is understood that, in the case that the ratio of the length to the width of the main body 200a is larger than 3, the main body 200a may experience a much more significant pivot torque when a force is applied on its right or left side. But the guiding component 100a still can maintain the moving direction of the main body 200a. However, it does not mean that the rotatable components 120a are exclusive to the main body 200a. In contrast to the conventional button, since the conventional button does not have the guiding component 100a, it is easily being pivoted to fail to activate the switch when the force applied thereon is uniform.

In this embodiment, the aforementioned computer casing 1a is a part of a computer host; that is, the computer host includes the switch assembly 5 and the casing 20. The computer host is, for example, a server, a desktop computer or a laptop computer.

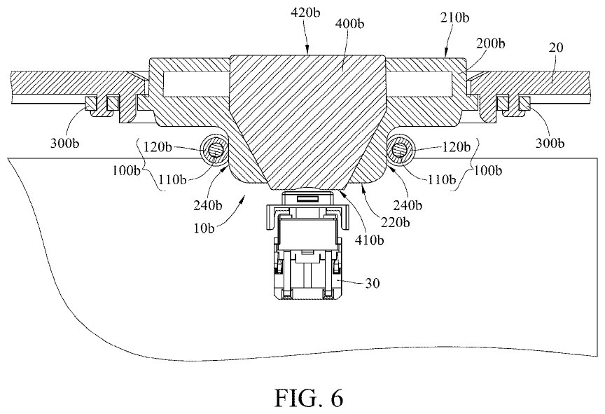

Moreover, the locations of the guiding surfaces 240a are not restricted. In some other embodiments, the two guiding surface may be respectively located on the surfaces of the grooves facing away from the central line L. As the embodiment provided in FIG. 6, FIG. 6 is a cross-sectional view of a button, a casing and a switch according to a second embodiment of the disclosure.

This embodiment provides a computer casing that is similar to the computer casing 1 of the first embodiment. For the purpose of illustration, the following paragraphs only illustrates the differences therebetween and components that are related to the differences.

In this embodiment, a button 10b includes two guiding components 100b, a main body 200b, two elastic arms 300b and a light guiding component 400b having an incident surface 410b and an illuminating surface 420b. Each of the two guiding components 100b includes a mount post 110b and a rotatable component 120b. The mount posts 110b are fixed to the casing 20, and the two rotatable components 120b are respectively and rotatably sleeved on the two mount posts 110b. The main body 200b has no groove, the main body 200b has a first side surface 210b, a second side surface 220b and two guiding surfaces 240b. The second side surface 220b is opposite to the first side surface 210b. In other words, the first side surface 210b is at the front side of the main body 200b, and the second side surface 220b is at the rear side of the main body 200b. The first side surface 210b is configured to be pressed by an external force, and the second side surface 220b can be moved toward or away from the switch 30 while the external force is applied on the first side surface 210b. The two guiding surfaces 240b are connected to the second side surface 220b and extend from the second side surface 220b toward the first side surface 210b. Two rotatable components 120b of the two guiding components 100b are respectively in contact with the two guiding surfaces 240b. Therefore, when the main body 200b is moved toward or away from the switch 30, the two rotatable components 120b of the two guiding components 100b can guide the movement of the main body 200b in a rotating manner.

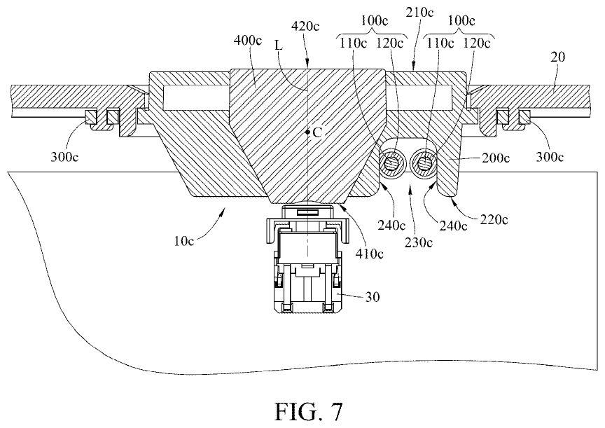

Then, please refer to FIG. 7. FIG. 7 is a cross-sectional view of a button, a casing and a switch according to a third embodiment of the disclosure.

This embodiment provides a computer casing that is similar to the computer casing 1 of the first embodiment. For the purpose of illustration, the following paragraphs only illustrates the differences therebetween and components that are related to the differences.

In this embodiment, a button 10c includes two guiding components 100c, a main body 200c, two elastic arms 300c and a light guiding component 400c having an incident surface 410c and an illuminating surface 420c. Each of the two guiding components 100c includes a mount post 110c and a rotatable component 120c. The mount posts 110c are fixed to the casing 20, and the two rotatable components 120c are respectively and rotatably sleeved on the two mount posts 110c. The main body 200c has a first side surface 210c, a second side surface 220c and a groove 230c. The second side surface 220c is opposite to the first side surface 210c. In other words, the first side surface 210c is at the front side of the main body 200c, and the second side surface 220c is at the rear side of the main body 200c. The first side surface 210c is configured to be pressed by an external force, and the second side surface 220c can be moved toward or away from the switch 30 while the external force is applied on the first side surface 210c. The groove 230c extends from the second side surface 220c toward the first side surface 210c, and the groove 230c is located on a side of a central line L passing through both the switch 30 and a central point C of the main body 200c. The groove 230c has two guiding surfaces 240c opposite to each other. That is, the two guiding surfaces 240c extend from the second side surface 220c toward the first side surface 210c. Two rotatable components 120c of the two guiding components 100c are separated from each other and respectively in contact with the two guiding surfaces 240c. Therefore, when the main body 200c is moved toward or away from the switch 30, the two rotatable components 120c of the two guiding components 100c can guide the movement of the main body 200c in a rotating manner.

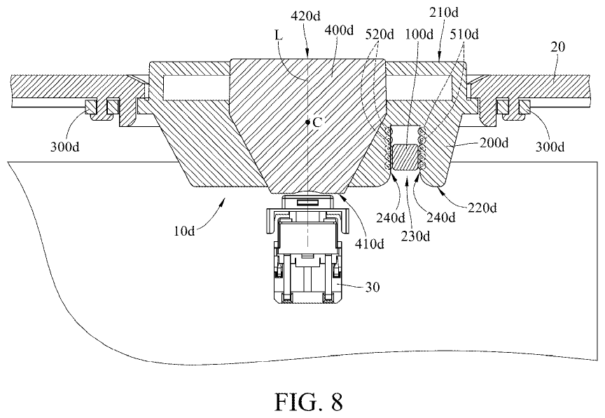

Then, please refer to FIG. 8. FIG. 8 is a cross-sectional view of a button, a casing and a switch according to a fourth embodiment of the disclosure.

This embodiment provides a computer casing that is similar to the computer casing 1 of the first embodiment. For the purpose of illustration, the following paragraphs only illustrates the differences therebetween and components that are related to the differences.

In this embodiment, a button 10d includes a guiding component 100d, a main body 200d, two elastic arms 300d and a light guiding component 400d having an incident surface 410d and an illuminating surface 420d, a plurality of first rotatable components 510d and a plurality of second rotatable components 520d. The guiding component 100d is, for example, a square post. The guiding component 100d is fixed on the casing 20. The main body 200d has a first side surface 210d, a second side surface 220d and a groove 230d. The second side surface 220d is opposite to the first side surface 210d. In other words, the first side surface 210d is at the front side of the main body 200d, and the second side surface 220d is at the rear side of the main body 200d. The first side surface 210d is configured to be pressed by an external force, and the second side surface 220d can be moved toward or away from the switch 30 while the external force is applied on the first side surface 210d. The groove 230d extend from the second side surface 220d toward the first side surface 210d, and the groove 230d is located on a side of a central line L passing through both the switch 30 and a central point C of the main body 200d. The groove 230d has two guiding surfaces 240d opposite to each other. That is, the two guiding surfaces 240d extend from the second side surface 220d toward the first side surface 210d.

The first rotatable components 510d and the second rotatable components 520d are disposed on the main body 200d and respectively arranged along the two guiding surfaces 240d, and two opposite sides of the guiding component 100d are respectively in contact with the first rotatable components 510d and the second rotatable components 520d. As such, when the main body 200d is moved toward or away from the switch 30, the first rotatable components 510d and the second rotatable components 520d can guide the movement of the main body 200d in a rotating manner.

According to the button, the switch assembly and the computer host as discussed above, by the rotatable components respectively in contact with the opposite guiding surfaces or the opposite sides of the guiding component, the main body is able to be guided in the desired direction and to be prevented from pivoting; that is, the main body is ensured to be moved in a straight direction toward the switch, such that the main body is prevent from being stuck in the casing and the light guiding component on the main body is prevented from being off track from the path for activating the switch, thereby enhancing the tactile feedback of the button.

In addition, during the movement of the main body moving toward the switch, the guiding surfaces force the rotatable components to rotate, therefore the friction between the main body and the guiding components can be reduced, thereby enabling the main body to move smoothly with respect to the casing.

Furthermore, the grooves are respectively located on two opposite of the central line, which allows the middle portion to have a larger area for accommodating the light guiding component, such that the light guiding component can be located closer to the switch and helps to decrease light loss.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. A button, comprising:
at least one guiding component; and
a main body having at least one guiding surface, and the at least one guiding surface being slidably connected to the at least one guiding component so as to allow the at least one guiding component to guide the main body to move.

2. The button according to claim 1, wherein the main body has a first side surface and a second side surface opposite to each other, the first side surface is configured to be pressed by an external force so as to force the second side surface to move toward a switch, and the at least one guiding surface is connected to the second side surface and extends from the second side surface toward the first side surface.

3. The button according to claim 1, wherein the main body has a first side surface, a second side surface and at least one groove, the second side surface is opposite to the first side surface, the at least one groove extends from the second side surface toward the first side surface, and the at least one guiding surface is a side surface of the at least one groove.

4. The button according to claim 3, wherein the at least one guiding component comprises a mount post and a rotatable component, the mount post is configured to be fixed in a casing, and the rotatable component is rotatably disposed on the mount post, the at least one guiding surface of the main body is in contact with the rotatable component so as to allow the rotatable component to guide the main body to move toward or away from a switch.

5. The button according to claim 4, wherein a central line is defined to pass through the switch and a central point of the main body, the quantity of the at least one groove is two, the quantity of the at least one guiding surface is two, the two grooves are respectively located on two opposite sides of the central line, each of the two grooves has two side surfaces opposite to each other, the two guiding surfaces are respectively the side surfaces of the two grooves facing away from the central line, the quantity of the at least one guiding component is two, and the two rotatable components of the two guiding components are respectively in contact with the two guiding surfaces.

6. The button according to claim 4, wherein a central line is defined to pass through both the switch and a central point of the main body, the quantity of the at least one groove is two, the quantity of the at least one guiding surface is two, the two grooves are spaced apart from the central line and are respectively located on two opposite sides of the central line, each of the two grooves has two side surfaces opposite to each other, the two guiding surfaces are respectively the side surfaces of the two grooves facing the central line, the quantity of the at least one guiding component is two, and the two rotatable components of the two guiding components are respectively in contact with the two guiding surfaces.

7. The button according to claim 4, wherein a central line is defined to pass through both the switch and a central point of the main body, the quantity of the at least one guiding surface is two, the at least one groove is located on a side of the central line, the two guiding surfaces are respectively two side surfaces of the at least one groove opposite to each other, the quantity of the at least one guiding component is two, and the two rotatable components of the two guiding components are respectively in contact with the two guiding surfaces.

8. The button according to claim 3, further comprising a plurality of rotatable components, wherein the at least one guiding component is configured to be fixed in a casing, the plurality of rotatable components are rotatably disposed on the main body and arranged along the at least guiding surface, and the at least one guiding component is in contact with the plurality of rotatable components.

9. The button according to claim 8, wherein the quantity of the at least one guiding surface is two, the two guiding surfaces are respectively two side surfaces of the at least one groove opposite to each other, the plurality of rotatable components are divided into a plurality of first rotatable components and a plurality of second rotatable components, the plurality of the first rotatable components and the plurality of second rotatable components are respectively arranged along the two guiding surfaces, and two opposite sides of the at least one guiding component are respectively in contact with the plurality of first rotatable components and the plurality of second rotatable components.

10. The button according to claim 1, further comprising at least one elastic arm, wherein an end of the at least one elastic arm is connected to the main body, and the other end of the at least one elastic arm is configured to be fixed to a casing.

11. The button according to claim 10, wherein the quantity of the at least one elastic arm is two, and the two elastic arms are respectively connected to two opposite sides of the main body.

12. The button according to claim 1, further comprising a light guiding component, wherein the light guiding component is embedded into the main body, the light guiding component has an incident surface and an illuminating surface, the incident surface faces a switch, the illuminating surface is exposed from a casing, and the incident surface is configured to receive and guide light emitted by a light source on the switch to the illuminating surface.

13. The button according to claim 1, wherein a ratio of a length of the main body to a width of the main body is larger than 3.

14. The button according to claim 1, wherein the at least one guiding surface is a curved surface.

15. A switch assembly, configured to be mounted to a casing, comprising:
a switch configured to be mounted in the casing; and
a button, configured to press the switch, comprising:
at least one guiding component configured to be fixed in the casing; and
a main body configured to be slidably disposed on the casing, the main body having at least one guiding surface, and the at least one guiding surface being slidably connected to the at least one guiding component so as to allow the at least one guiding component to guide the main body to move toward or away from the switch.

16. The switch assembly according to claim 15, wherein the at least one guiding component comprises a mount post and a rotatable component, the mount post is configured to be fixed in the casing, and the rotatable component is rotatably disposed on the mount post, the at least one guiding surface of the main body is in contact with the rotatable component so as to allow the rotatable component to guide the main body to move toward or away from the switch.

17. A computer host, comprising:
a casing;
a switch mounted in the casing; and
a button, configured to press the switch, comprising:
at least one guiding component fixed in the casing; and
a main body slidably disposed on the casing, the main body having at least one guiding surface, and the at least one guiding surface of the main body being slidably connected to the at least one guiding component so as to allow the at least one guiding component to guide the main body to move toward or away from the switch.

18. The computer host according to claim 17, wherein the at least one guiding component comprises a mount post and a rotatable component, the mount post is fixed in the casing, and the rotatable component is rotatably disposed on the mount post, the at least one guiding surface of the main body is in contact with the rotatable component so as to allow the rotatable component to guide the main body to move toward or away from the switch.

19. The computer host according to claim 18, wherein the main body has a first side surface, a second side surface and at least one groove, the second side surface is opposite to the first side surface, the at least one groove extends from the second side surface toward the first side surface, and the at least one guiding surface is a side surface of the at least one groove.

20. The computer host according to claim 19, wherein a central line is defined to pass through both the switch and a central point of the main body, the quantity of the at least one groove is two, the quantity of the at least one guiding surface is two, the two grooves are spaced apart from the central line and are respectively located on two opposite sides of the central line, each of the two grooves has two side surfaces opposite to each other, the two guiding surfaces are respectively the side surfaces of the two grooves facing the central line, the quantity of the at least one guiding component is two, and the two rotatable components of the two guiding components are respectively in contact with the two guiding surfaces.
